(19) United States
(12) Patent Application Publication
(10) Pub. No.: US 2023/0243463 A1
(43) Pub. Date: Aug. 3, 2023

(54) CONNECTION ASSEMBLY AND GIMBAL DEVICE

(71) Applicant: SZ DJI TECHNOLOGY CO., LTD., Shenzhen (CN)

(72) Inventors: Shimeng BEI, Shenzhen (CN); Jian YANG, Shenzhen (CN); Feng ZHU, Shenzhen (CN)

(73) Assignee: SZ DJI TECHNOLOGY CO., LTD., Shenzhen (CN)

(21) Appl. No.: 18/132,786

(22) Filed: Apr. 10, 2023

Related U.S. Application Data
(63) Continuation of application No. PCT/CN2020/121296, filed on Oct. 15, 2020.

(51) Int. Cl. F16M 13/04; F16M 11/20; G03B 17/56

(52) U.S. Cl. CPC F16M 13/04; F16M 11/2021; G03B 17/561; F16M 2200/022

(57) ABSTRACT

A connection assembly and a gimbal device are provided. The connection assembly includes a first connection member, a second connection member and a locking structure. The first connection member is connected to the gimbal. The second connection member is connected to the first connection member. When the locking structure is in a locking state, the locking structure may lock the first connection member and the second connection member. When the locking structure is in a released state, the first connection member and the second connection member may rotate relative to each other, so that the gimbal may be switched between at least two operation postures.

### RELATED APPLICATIONS

This application is a continuation application of PCT application No. PCT/CN2020/121296, filed on Oct. 15, 2020, and the content of which is incorporated herein by reference in its entirety.

### TECHNICAL FIELD

The present application relates to the field of gimbal technologies, and in particular, to a connection assembly and a gimbal device.

### BACKGROUND

When a user performs photographing with a handheld photographing apparatus such as a camera, to avoid compromising the quality of a captured image due to jitter caused by the user, a handheld gimbal is usually used to secure the handheld photographing apparatus, so as to adjust a photographing angle during photographing and keep the handheld photographing apparatus stably at a fixed photographing angle. However, existing handheld gimbals are complicated to disassemble and assemble when switching between different operation postures, and thus user experience is not good.

### BRIEF SUMMARY

In view of the foregoing, the present disclosure provides a connection assembly and a gimbal device.

According to a first aspect, some exemplary embodiments of the present disclosure provide a connection assembly for a gimbal, including: a first connection member, being configured to connect to a gimbal; a second connection member, being configured to connect to the first connection member; and a locking structure having a locking state and a released state, where in the locking state, the locking structure is capable of locking the first connection member and the second connection member, and in the released state, the locking structure allows the first connection member and the second connection member to rotate relative to each other so as to allow the gimbal to switch between at least two operation postures.

Some exemplary embodiments of the present disclosure provide a connection assembly and a gimbal device. When the gimbal switches between different operation postures, operation of attitude switching is simple and convenient, thereby improving user experience.

It should be understood that the foregoing general description and the following detailed description are merely illustrative and explanatory, and are not intended to limit the present disclosure.

### BRIEF DESCRIPTION OF THE DRAWINGS

To describe the technical solutions in some exemplary embodiments of the present disclosure, the accompanying drawings will be briefly described below. Apparently, the accompanying drawings described below are only some exemplary embodiments of the present disclosure. A person of ordinary skill in the art may further obtain other drawings based on these accompanying drawings without creative efforts.

FIG. 1 is a schematic structural diagram of a gimbal device according to some exemplary embodiments of the present disclosure;

FIG. 2 is a schematic structural diagram of a gimbal device according to some exemplary embodiments of the present disclosure;

FIG. 3 is a schematic structural diagram of a gimbal device according to some exemplary embodiments of the present disclosure;

FIG. 4 is a schematic structural diagram of a gimbal device according to some exemplary embodiments of the present disclosure;

FIG. 5 is a schematic structural diagram of a gimbal device according to some exemplary embodiments of the present disclosure;

FIG. 6 is a schematic structural diagram of a gimbal device according to some exemplary embodiments of the present disclosure;

FIG. 7 is a schematic structural diagram of a part of a gimbal device according to some exemplary embodiments of the present disclosure;

FIG. 8 is a schematic structural diagram of a connection assembly according to some exemplary embodiments of the present disclosure;

FIG. 9 is a schematic exploded diagram of a part of a gimbal device according to some exemplary embodiments of the present disclosure;

FIG. 10 is a schematic exploded diagram of a part of a gimbal device according to some exemplary embodiments of the present disclosure;

FIG. 11 is a sectional view of a part of a connection assembly according to some exemplary embodiments of the present disclosure;

FIG. 12 is a schematic structural diagram of a mounting portion according to some exemplary embodiments of the present disclosure;

FIG. 13 is a schematic structural diagram of a part of a gimbal according to some exemplary embodiments of the present disclosure, where a grip body and a control body are shown; and

FIG. 14 is a schematic structural diagram of a part of a gimbal device according to some exemplary embodiments of the present disclosure.

### REFERENCE NUMERALS

1000. gimbal device;

101. gimbal; 1011. motor; 1012. frame; 1013. control body; 1014. grip body; 1015. sliding portion;

102. connection assembly;

10. first connection member; 11. gimbal connection portion; 12. extension portion; 121. first extension arm; 122. second extension arm; 13. limiting portion; 14. fixing portion;

20. second connection member; 21. first beam; 22. rotating portion; 221. first rotating arm; 222. second rotating arm; 23. first handle; 24. first matching portion; 25. second matching portion;

30. locking structure; 31. locking member; 311. operating portion; 312. penetrating portion;

40. second beam; 41. third assembly portion; 50. second handle;

60. mounting portion; 61. first assembly portion; 611. fixed base; 612. movable member; 613. knob; 614. accommodation slot; 62. second assembly portion;

71. elastic member; 72. pre-tensioning member; 81. control portion; 82. power supply; 83. charging port; 90. electrical connection wire; and

2000. photographing device.

### DETAILED DESCRIPTION

The technical solutions in some exemplary embodiments of the present disclosure will be described below with reference to the accompanying drawings. Apparently, the described embodiments are merely some rather than all of the embodiments of the present disclosure. All other embodiments obtained by a person of ordinary skill in the art based on these exemplary embodiments of the present disclosure without creative efforts shall fall within the scope of protection of the present disclosure.

It should be understood that the terms used herein are for the purpose of describing specific exemplary embodiments only and are not intended to limit the present disclosure. As used herein, the singular forms “a”, “an” and “the” are intended to include the plural forms unless the context explicitly indicates otherwise.

It should also be further understood that the term “and/or” as used herein refers to one of or any or all possible combinations of associated items that are listed, and includes these combinations.

Some exemplary embodiments of the present disclosure will be described in detail below with reference to the accompanying drawings. If no conflict occurs, the following exemplary embodiments and their features may be combined with one another.

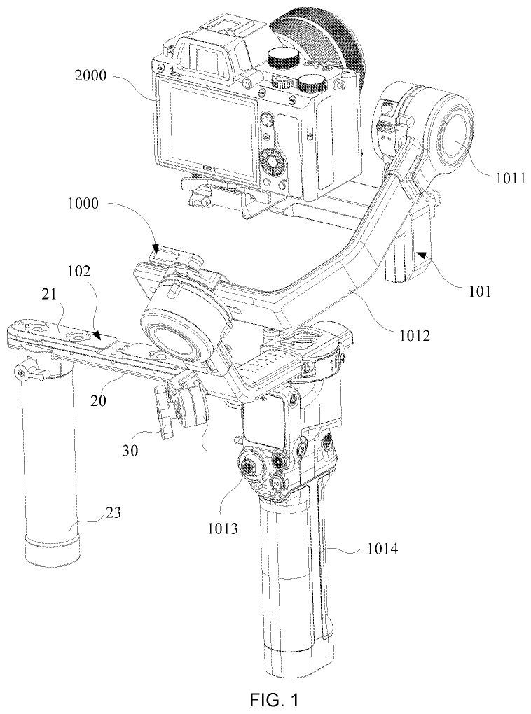

Referring to FIG. 1 to FIG. 6, a gimbal device 1000 according to some exemplary embodiments of the present disclosure may include a gimbal 101 and a connection assembly 102. The gimbal 101 may be connected to the connection assembly 102. A photographing device 2000 may be carried on the gimbal 101. The photographing device 2000 may include at least one of a camera, a video camera, a mobile phone, or the like. The connection assembly 102 may be used in conjunction with the gimbal 101, and may be used together for video photographing, entertainment, taking a selfie, or other purpose. The gimbal 101 may be a single-axis gimbal 101, a two-axis gimbal 101, a three-axis gimbal 101, or a different multi-axis gimbal 101, which is not limited herein.

Referring to FIG. 1 to FIG. 6, in some exemplary embodiments, the gimbal 101 may include a motor 1011, a frame 1012, and a control body 1013. The motor 1011 may be connected to the frame 1012 and configured to drive the frame 1012 to rotate relative to the control body 1013. The motor 1011 may be at least one of a yaw motor, a roll motor, or a pitch motor. A control key, such as a physical key or a virtual key, may be disposed on the control body 1013. A user may control the frame 1012 via the control key on the control body 1013, so as to control the photographing device 2000 mounted on the gimbal 101 to start, shut down, or photograph. A use may also control the motor 1011 so as to adjust an attitude change and the like of the frame 1012 or the photographing device 2000.

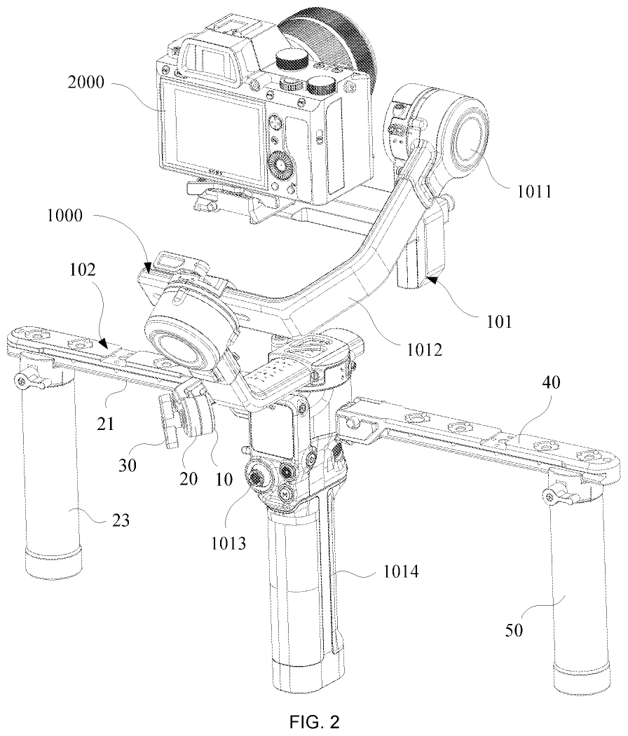

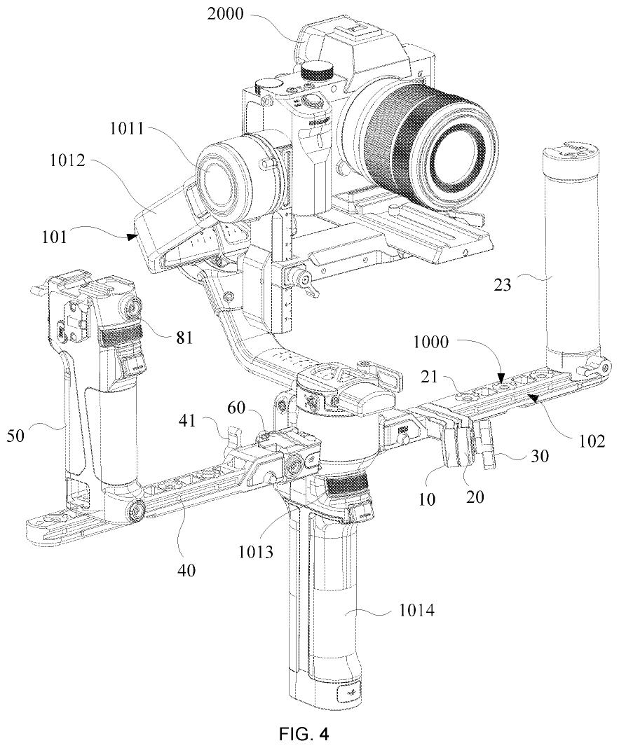

Referring to FIG. 1, FIG. 2, and FIG. 4 to FIG. 6, in some exemplary embodiments, the gimbal 101 may include a grip body 1014. The grip body 1014 may be connected to the control body 1013. A power supply 82 may be disposed in the grip body 1014 to supply power to at least one of the control body 1013, the motor 1011, or the like. It can be understood that the grip body 1014 and the control body 1013 may be fixedly connected in a non-detachable manner or may be integrally formed. The grip body 1014 and the control body 1013 may alternatively be detachably connected.

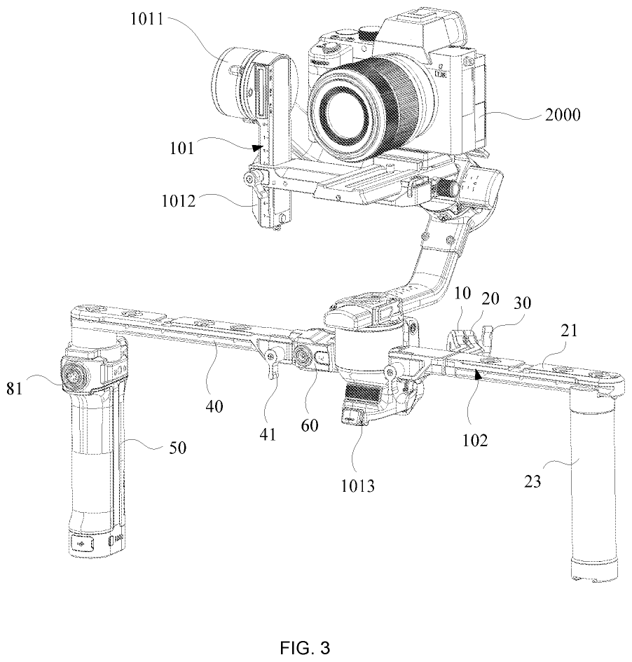

It can be understood that the grip body 1014 may alternatively be omitted. In this case, the connection assembly 102 and the gimbal 101 may be used for handheld photographing by the user, as shown in FIG. 3. Alternatively, the connection assembly 102 and the gimbal 101 may be carried on another platform, such as on a vehicle, an aircraft, or a robot.

Referring to FIG. 1 to FIG. 6, in some exemplary embodiments, the connection assembly 102 may include a first connection member 10, a second connection member 20, and a locking structure 30. The first connection member 10 may be connected to the gimbal 101. The second connection member 20 may be connected to the first connection member 10. The locking structure 30 may include a locking state and a released state. When the locking structure 30 is in the locking state, the locking structure 30 may be capable of locking the first connection member 10 and the second connection member 20. When the locking structure 30 is in the released state, the first connection member 10 and the second connection member 20 may be rotatable relative to each other, so that the gimbal 101 is allowed to switch between at least two operation postures.

The connection assembly 102 and the locking structure 30 in some exemplary embodiments may lock or unlock the first connection member 10 and the second connection member 20, so that the connection assembly 102 may support various ways of using the gimbal 101 or adapt to various operation postures of the gimbal 101, thereby adapting to different photographing environments and providing assistance for a photographing effect required by the user, and providing diversified disclosure scenarios.

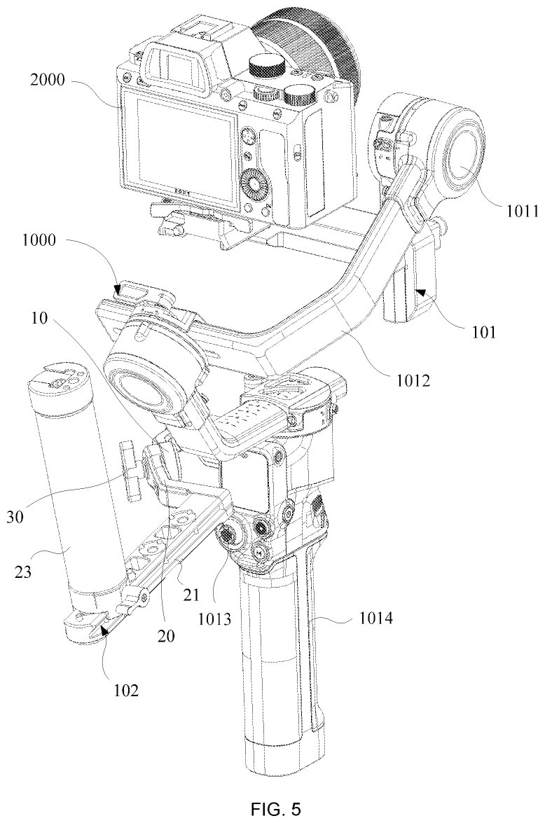

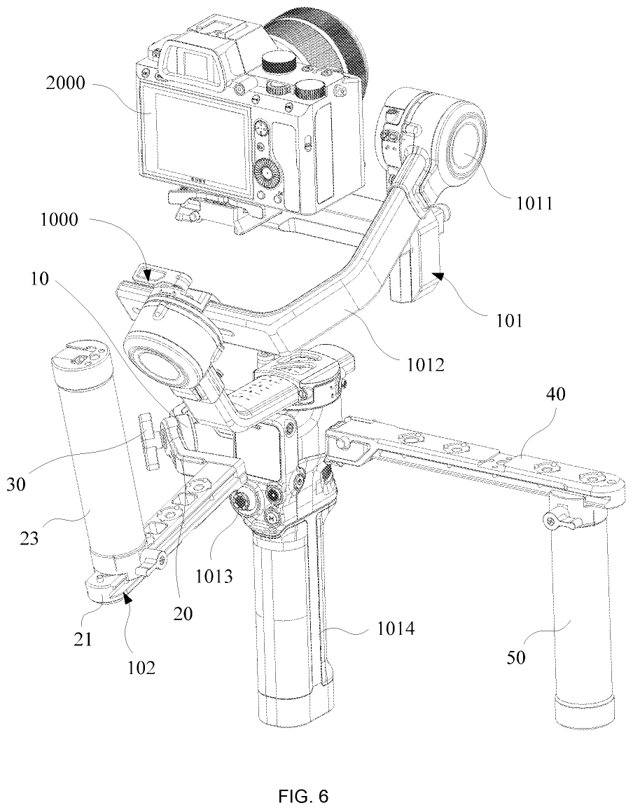

In addition, when the gimbal 101 needs to switch between different operation postures, only the locking structure 30 may need to be released, so that the first connection member 10 and the second connection member 20 may rotate relative to each other. After the locking structure 30 is released, the first connection member 10 and the second connection member 20 may rotate relative to each other, so that the gimbal 101 may switch from a current operation posture to a target operation posture, for example, switch from the operation posture shown in FIG. 1 (or FIG. 2) to the operation posture shown in FIG. 5 (or FIG. 6). When the first connection member 10 and the second connection member 20 relatively rotate to the target operation posture, the locking structure 30 is locked, thereby locking the first connection member 10 and the second connection member 20. Therefore, when the connection assembly 102 and the gimbal 101 of the present disclosure switch between different operation postures, an attitude switching operation is simple and convenient, and the first connection member 10 or the second connection member 20 do not need to be removed from the gimbal 101 and then mounted back on the gimbal 101, thereby improving user experience.

It can be understood that the at least two operation postures herein may include the current operation posture and the target operation posture.

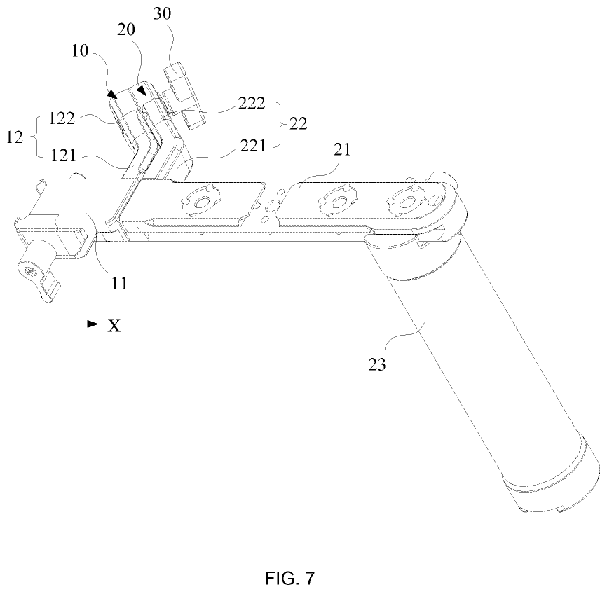

Referring to FIG. 7 to FIG. 11, in some exemplary embodiments, the first connection member 10 may include a gimbal connection portion 11 and an extension portion 12. The gimbal connection portion 11 may be connected to the gimbal 101. The extension portion 12 may be connected to the gimbal connection portion 11. The extension portion 12 is connectable to the second connection member 20 or the extension portion 12 is rotatable relative to the second connection member 20.

Specifically, when the locking structure 30 is in the locking state, the locking structure 30 locks the extension portion 12 and the second connection member 20, and the extension portion 12 and the second connection member 20 cannot rotate relative to each other, thereby ensuring that the gimbal 101 can provide, in a corresponding operation posture, stable photographing conditions for the photographing device 2000. When the locking structure 30 is in the released state, the locking structure 30 may unlock the extension portion 12 and the second connection member 20, and the extension portion 12 is rotatable relative to the second connection member 20, so that the gimbal 101 may switch between at least two operation postures.

In some exemplary embodiments, the gimbal connection portion 11 may be fixedly connected to the gimbal 101 in a non-detachable manner. In some exemplary embodiments, the gimbal connection portion 11 may alternatively be detachably connected to the gimbal 101. Exemplarily, the gimbal connection portion 11 may be connected to the control body 1013 of the gimbal 101 in a detachable manner or a non-detachable manner. For example, the gimbal connection portion 11 may be detachably connected to the control body 1013 of the gimbal 101 through a snap connection, a quick release connection, or the like.

In some exemplary embodiments, the gimbal connection portion 11 and the extension portion 12 may be integrally formed. In some exemplary embodiments, the gimbal connection portion 11 and the extension portion 12 may alternatively be disposed in a split manner. For example, the gimbal connection portion 11 and the extension portion 12 may be connected and fixed through a gluing connection, a quick release connection, a snap connection, or the like.

Referring to FIG. 7 to FIG. 11, in some exemplary embodiments, the extension portion 12 may include a first extension arm 121 and a second extension arm 122. One end of the first extension arm 121 may be connected to the gimbal connection portion 11. The second extension arm 122 may be formed by bending and extending the other end of the first extension arm 121. The second extension arm 122 is connectable to the second connection member 20 or is rotatable relative to the second connection member 20.

Specifically, when the locking structure 30 is in the locking state, the locking structure 30 locks the second extension arm 122 and the second connection member 20, and thus the second extension arm 122 and the second connection member 20 may not rotate relative to each other. When the locking structure 30 is in the released state, the locking structure 30 unlocks the second extension arm 122 and the second connection member 20, so that the second extension arm 122 may rotate relative to the second connection member 20.

Referring to FIG. 7 to FIG. 11, exemplarily, the first extension arm 121 may be disposed on the gimbal connection portion 11 in a protruding manner.

Exemplarily, an angle between the first extension arm 121 and the gimbal connection portion 11 may be any proper angle. For example, the first extension arm 121 may be perpendicular to the gimbal connection portion 11. It should be understood that, being perpendicular may include a case of being substantially perpendicular, that is, being perpendicular may include a case where the angle therebetween may be 80°, 85°, 90°, or any another proper angle between 80° and 90°.

Exemplarily, an angle between the first extension arm 121 and the second extension arm 122 may be any proper angle. For example, the angle between the first extension arm 121 and the second extension arm 122 may range from 100° to 170°, that is, may be 100°, 120°, 150°, 160°, 170°, or any other proper angle between 100° and 170°.

In some exemplary embodiments, the second extension arm 122 may be formed by bending and extending the other end of the first extension arm 121 toward a side away from the second connection member 20. Exemplarily, the second extension arm 122 and the gimbal connection portion 11 may be respectively connected at opposite ends of the first extension arm 121.

Exemplarily, the second extension arm 122 may be formed by bending and extending the other end of the first extension arm 121 toward a side close to the gimbal 101.

Referring to FIG. 7 to FIG. 11, in some exemplary embodiments, the second connection member 20 may include a first beam 21 and a rotating portion 22. The rotating portion 22 may be connected to the first beam 21 and the extension portion 12. The rotating portion 22 is connectable to the second extension arm 122 or the rotating portion 22 is rotatable relative to the second extension arm 122.

Exemplarily, when the locking structure 30 is in the locking state, the locking structure 30 locks the second extension arm 122 and the rotating portion 22, and the second extension arm 122 and the rotating portion 22 cannot rotate relative to each other, thereby ensuring that the gimbal 101 may provide, in a corresponding operation posture, stable photographing conditions for the photographing device 2000. When the locking structure 30 is in the released state, the locking structure 30 is unlocked, and the second extension arm 122 and the rotating portion 22 may rotate relative to each other, so that the gimbal 101 can be switched between at least two operation postures.

In some exemplary embodiments, the first beam 21 and the rotating portion 22 may be integrally formed or disposed in a split manner. For example, the first beam 21 and the rotating portion 22 may be connected and fixed through a gluing connection, a quick release connection, a snap connection, or the like.

In some exemplary embodiments, a shape of the rotating portion 22 may be matched with a shape of the extension portion 12, to ensure that the rotating portion 22 and the extension portion 12 are rotatable relative to each other. The shape of the rotating portion 22 and the shape of the extension portion 12 may be the same or different, as long as the rotating portion 22 and the extension portion 12 are rotatable relative to each other.

Referring to FIG. 7 to FIG. 11, in some exemplary embodiments, the rotating portion 22 may include a first rotating arm 221 and a second rotating arm 222. One end of the first rotating arm 221 may be connected to the first beam 21. The second rotating arm 222 may be formed by bending and extending the other end of the first rotating arm 221. The second rotating arm 222 is connectable to the second extension arm 122 or is rotatable relative to the second extension arm 122.

Exemplarily, when the locking structure 30 is in the locking state, the locking structure 30 locks the second extension arm 122 and the second rotating arm 222, and the second extension arm 122 and the second rotating arm 222 cannot rotate relative to each other, thereby ensuring that the gimbal 101 can provide, in a corresponding operation posture, stable photographing conditions for the photographing device 2000. When the locking structure 30 is in the released state, the locking structure 30 unlocks the second extension arm 122 and the second rotating arm 222, and the second extension arm 122 and the second rotating arm 222 may rotate relative to each other, so that the gimbal 101 may switch between at least two operation postures, for example, the gimbal 101 switches from the attitude in FIG. 1 (or FIG. 2) to the attitude in FIG. 5 (or FIG. 6).

An angle between the first rotating arm 221 and the second rotating arm 222 may be any proper angle. For example, the angle between the first rotating arm 221 and the second rotating arm 222 may range from 100° to 170°, that is, may be 100°, 120°, 150°, 160°, 170°, or any other proper angle between 100° and 170°.

In some exemplary embodiments, the second rotating arm 222 may be formed by bending and extending the other end of the first rotating arm 221 toward a side away from the first beam 21. Exemplarily, the second rotating arm 222 and the first beam 21 may be respectively connected at opposite ends of the first rotating arm 221.

Exemplarily, the second rotating arm 222 may be formed by bending and extending the other end of the first rotating arm 221 toward a side close to the gimbal 101.

It can be understood that the use mode or operation posture of the gimbal 101 may be used to obtain corresponding movement of the gimbal 101 so as to achieve a required photographing mode (such as pushing, pulling, panning, moving the lens, or the like), in order to provide the photographing device 2000 with various assistances. The corresponding movement of the gimbal 101 may be a position change of the gimbal 101 in the horizontal direction and a change in a tilt angle of the gimbal 101 relative to the horizontal direction, or may be a position change of the gimbal 101 in the vertical direction and a change in a tilt angle of the gimbal 101 relative to the vertical direction, or the like.

In some exemplary embodiments, the at least two operation postures may include a hand-holding attitude and a hand-carrying attitude. The hand-holding attitude may include a one-hand holding attitude and a two-hand holding attitude. The hand-carrying attitude may include a one-hand carrying attitude and a two-hand carrying attitude.

Exemplarily, the hand-holding attitude may include attitudes shown in FIG. 1 to FIG. 3. The hand-carrying attitude may include attitudes shown in FIG. 4 and FIG. 5. The attitude shown in FIG. 6 may be a one-hand holding attitude in some scenarios, and may be a one-hand carrying attitude in some other scenarios.

In some exemplary embodiments, there may be at least two connection manners between the first connection member 10 and the second connection member 20. For example, different positions and/or directions of connection between the first connection member 10 and the second connection member 20 may form at least two different connection manners. Different connection manners of the first connection member 10 and the second connection member 20 may support various use modes of the gimbal 101 and/or adapt to various operation postures of the gimbal 101. A user may select an appropriate connection manner to connect the first connection member 10 and the second connection member 20 according to actual requirements, so as to adapt to photographing needs of the user and photographing environment, for example, photographing by carrying the gimbal 101 with one hand, by carrying the gimbal 101 with both hands, by holding the gimbal 101 with one hand, or by holding the gimbal 101 with both hands.

Exemplarily, the at least two connection manners may include a first connection manner and a second connection manner. One of the first connection manner and the second connection manner may correspond to the hand-holding attitude, and one of the first connection manner and the second connection manner may correspond to the hand-carrying attitude.

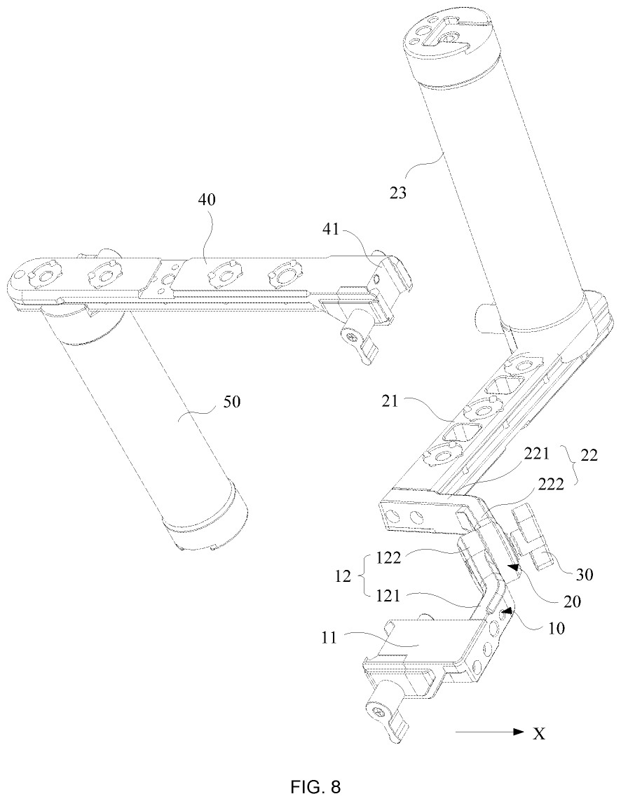

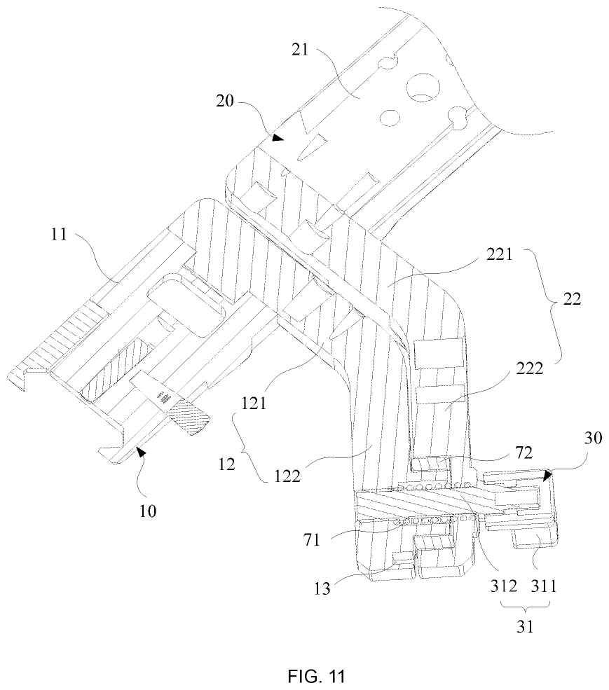

Exemplarily, the first connection manner may be that the first connection member 10 and the second connection member 20 are connected based on the connection manners shown in FIG. 1 to FIG. 4, FIG. 7, and FIG. 11. The second connection manner may be that the first connection member 10 and the second connection member 20 are connected based on the connection manners shown in FIG. 5, FIG. 6, and FIG. 8.

It can be understood that the first connection member 10 and the second connection member 20 may be rotatable relative to each other, so that the connection of the first connection member 10 and the second connection member 20 may switch between the first connection manner and the second connection manner. In this way, the gimbal 101 may switch between the hand-holding attitude and the hand-carrying attitude.

Referring to FIG. 1 and FIG. 2, when the first connection member 10 and the second connection member 20 are connected in the first connection manner, the gimbal 101 is in the hand-holding attitude. Referring to FIG. 5, when the first connection member 10 and the second connection member 20 are connected in the second connection manner, the gimbal 101 is in the hand-carrying attitude. Referring to FIG. 6, when the first connection member 10 and the second connection member 20 are connected in the second connection manner, the gimbal 101 may be used in the one-hand carrying attitude or the one-hand holding attitude. However, the present disclosure is not limited to this. The gimbal 101 may alternatively be used in the two-hand carrying attitude or two-hand holding attitude. In some exemplary embodiments, when the gimbal 101 is in the hand-holding attitude or the hand-carrying attitude, the photographing device 2000 is in a photographing state. In some exemplary embodiments, when the gimbal 101 is in the hand-holding attitude, the motor 1011 may drive the frame 1012 to rotate relative to the control body 1013 to perform photographing. When the gimbal 101 is in the hand-carrying attitude, the photographing device 2000 mounted on the gimbal 101 may stop photographing or pause. The hand-holding attitude is a holding manner in which an operator holds the grip body 1014 of the gimbal 101, where the gimbal 101 and the photographing device 2000 as a whole are generally located above the grip body 1014. The hand-carrying attitude is a holding manner in which a first handle 23 of the gimbal 101 is carried in a pulling manner, where the gimbal 101 and the photographing device 2000 as a whole are located below the first handle 23.

Referring to FIG. 4, in some exemplary embodiments, when the first connection member 10 and the second connection member 20 are connected in the first connection manner, the gimbal 101 may be in the hand-carrying attitude. When the first connection member 10 and the second connection member 20 are connected in the second connection manner, the gimbal 101 may be in the hand-holding attitude. For example, positions and/or directions of connection between the first connection member 10 and the gimbal 101 may be adjusted, so that when the first connection member 10 and the second connection member 20 are connected in the first connection manner, the gimbal 101 may be in the hand-carrying attitude.

Referring to FIG. 7, in some exemplary embodiments, when the first connection member 10 and the second connection member 20 are connected in the first connection manner, the first rotating arm 221 may be parallel to the first extension arm 121. It should be understood that, being parallel herein may include a case of being substantially parallel, that is, being parallel may include a case where the angle therebetween may be 0°, 5°, 10°, or any other proper angle between 0° and 10°.

Referring to FIG. 7, in some exemplary embodiments, when the first connection member 10 and the second connection member 20 are connected in the first connection manner, the second rotating arm 222 may be parallel to the second extension arm 122. In this way, relative rotation between the second extension arm 122 and the second rotating arm 222 may be allowed.

Referring to FIG. 7, in some exemplary embodiments, when the first connection member 10 and the second connection member 20 are connected in a first connection manner, the first rotating arm 221 may be attached to the first extension arm 121, so that the connection assembly 102 is compact in the hand-holding attitude, thereby reducing space occupied by the connection assembly 102. It should be understood that being attached herein may include a case of substantially being attached. For example, due to machining errors, some parts of the first rotating arm 221 and the first extension arm 121 may not be attached, while other parts thereof may be attached.

Referring to FIG. 7, in some exemplary embodiments, when the first connection member 10 and the second connection member 20 are connected in the first connection manner, the second rotating arm 222 may be attached to the second extension arm 122, so that the connection assembly 102 is compact in the hand-holding attitude, thereby reducing space occupied by the connection assembly 102.

Referring to FIG. 7, in some exemplary embodiments, when the first connection member 10 and the second connection member 20 are connected in the first connection manner, the first rotating arm 221 may be perpendicular to the gimbal connection portion 11. Exemplarily, the first rotating arm 221 may be disposed on the first beam 21 in a protruding manner. A longitudinal extending direction of the gimbal connection portion 11 may be perpendicular to the protruding direction of the first rotating arm 221. Exemplarily, the longitudinal extending direction of the gimbal connection portion 11 may be the X direction shown in FIG. 8.

Referring to FIG. 7, in some exemplary embodiments, when the first connection member 10 and the second connection member 20 are connected in the first connection manner, the gimbal connection portion 11 and the first beam 21 may be arranged in a collinear manner. It should be understood that, the gimbal connection portion 11 and the first beam 21 being arranged in a collinear manner may include a case that the gimbal connection portion 11 and the first beam 21 are collinear or substantially collinear.

In some exemplary embodiments, a length of the first extension arm 121 may be equal to or substantially equal to a length of the first rotating arm 221, and a length of the second extension arm 122 may be equal to or substantially equal to a length of the second rotating arm 222. In this way, when the first connection member 10 and the second connection member 20 are connected in the first connection manner, the extension portion 12 and the rotating portion 22 can be better matched, so as to ensure that the extension portion 12 and the rotating portion 22 can rotate effectively.

Referring to FIG. 8, in some exemplary embodiments, when the first connection member 10 and the second connection member 20 are connected in the second connection manner, an angle between the first rotating arm 221 and the first extension arm 121 may be an acute angle, and the second rotating arm 222 may be parallel to the second extension arm 122. Exemplarily, when the first connection member 10 and the second connection member 20 are connected in the second connection manner, the angle between the first rotating arm 221 and the first extension arm 121 may be 30°, 45°, 60°, 80°, or any other proper angle between 30° to 80°.

Referring to FIG. 8, in some exemplary embodiments, when the first connection member 10 and the second connection member 20 are connected in the second connection manner, both the second extension arm 122 and the second rotating arm 222 may be located between the first extension arm 121 and the first rotating arm 221.

Referring to FIG. 8, in some exemplary embodiments, when the first connection member 10 and the second connection member 20 are connected in the second connection manner, the extension portion 12 and the rotating portion 22 may respectively extend in opposite directions from a position where the extension portion 12 and the rotating portion 22 are connected.

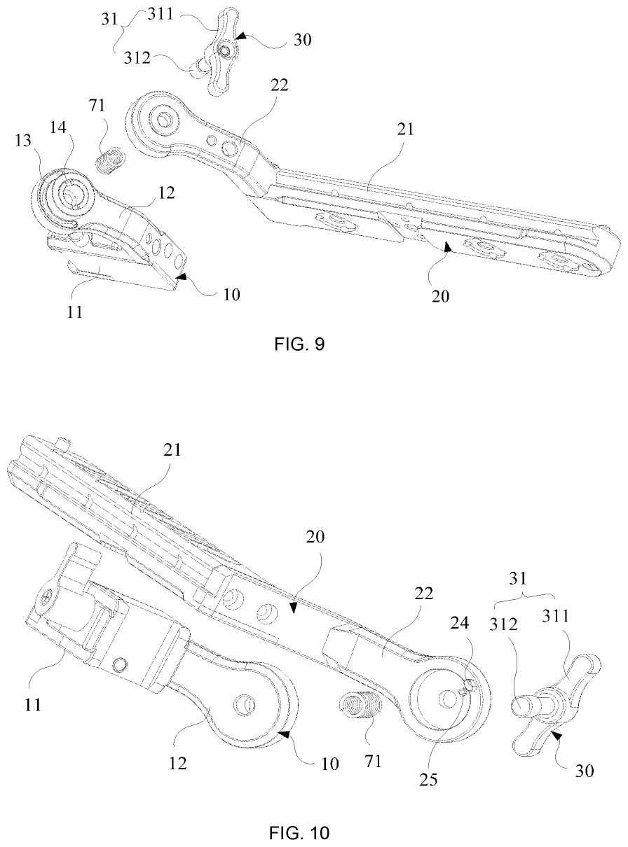

Referring to FIG. 8, in some exemplary embodiments, when the first connection member 10 and the second connection member 20 are connected in the second connection manner, the first rotating arm 221 and the gimbal connection portion 11 may be disposed in parallel at an interval. Exemplarily, the first rotating arm 221 may be disposed on the first beam 21 in a protruding manner. A longitudinal extending direction of the gimbal connection portion 11 may be parallel to the protruding direction of the first rotating arm 221. Exemplarily, the longitudinal extending direction of the gimbal connection portion 11 may be the X direction shown in FIG. 9.

Referring to FIG. 8, in some exemplary embodiments, when the first connection member 10 and the second connection member 20 are connected in the second connection manner, the gimbal connection portion 11 may be perpendicular to the first beam 21. Exemplarily, the longitudinal extending direction of the gimbal connection portion 11 may be perpendicular to a longitudinal extending direction of the first beam 21.

Referring to FIG. 1 to FIG. 8, in some exemplary embodiments, the second connection member 20 may further include a first handle 23. The first handle 23 may be connected to the first beam 21. In this way, a user may hold the first handle 23 for photographing.

In some exemplary embodiments, the first beam 21 may alternatively be omitted, and the first handle 23 may be directly connected to the first rotating arm 221.

In some exemplary embodiments, the first connection member 10, the second connection member 20, and the locking structure 30 may cooperate to form a first combined body, and a quantity of the first combined body may be one, two, three, or more, which is not limited herein.

Referring to FIG. 2 to FIG. 4, and FIG. 6 to FIG. 8, in some exemplary embodiments, the connection assembly 102 may further include a second beam 40 and a second handle 50. The second beam 40 may be detachably connected to the gimbal 101. The second handle 50 may be connected to the second beam 40. Specifically, the second beam 40 may be detachably connected to the control body 1013 of the gimbal 101 through a snap connection, a quick release connection, or the like.

Exemplarily, the user may hold the first handle 23 and the second handle 50 with both hands, so as to save more effort. Moreover, when the user moves, force exerted by the user on the connection assembly 102 is more even, which is helpful for the user to more stably perform photographing. Certainly, the user may alternatively hold one of the first handle 23 and the second handle 50 to perform photographing or use, which is not limited herein.

Referring to FIG. 3 and FIG. 4, in some exemplary embodiments, the second beam 40 may be detachably connected to the control body 1013 through a mounting portion 60. Exemplarily, the second beam 40 and the control body 1013 may be respectively detachably connected to the mounting portion 60. Exemplarily, one of the second beam 40 and the control body 1013 may be detachably connected to the mounting portion 60, and the other may be fixed to the mounting portion 60 in a non-detachable manner or may be integrally formed with the mounting portion 60.

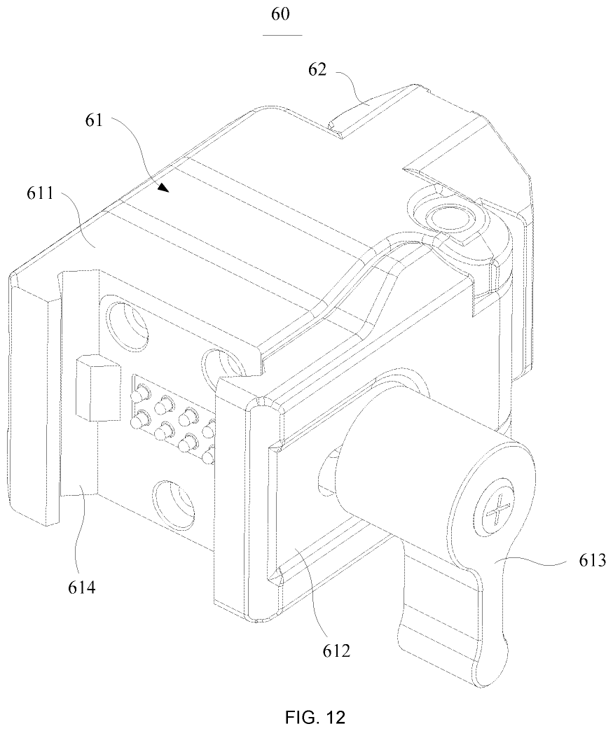

Referring to FIG. 12, in some exemplary embodiments, the mounting portion 60 may include a first assembly portion 61 and a second assembly portion 62 connected to the first mounting portion 61. The first assembly portion 61 may be connected to the control body 1013, and the second assembly portion 62 may be connected to the second beam 40. The first assembly portion 61 may include a fixed base 611, a movable member 612, and a knob 613. The fixed base 611 may be connected to the second assembly portion 62. The fixed base 611 may cooperate with the movable member 612 to form an accommodation slot 614, and the movable member 612 may move relative to the fixed base 611 to change a size of the accommodation slot 614.

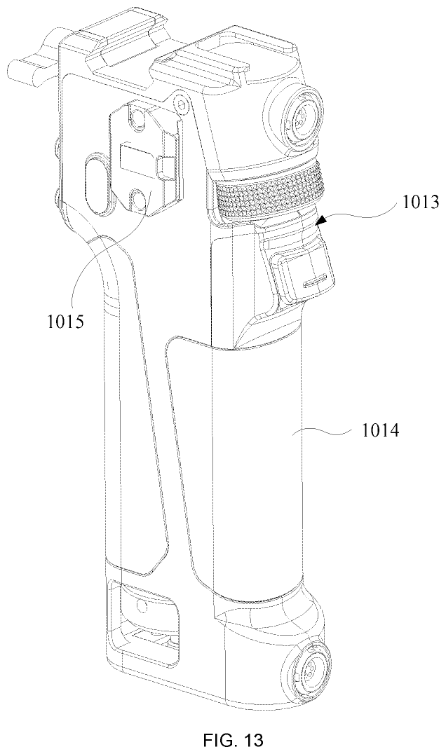

Referring to FIG. 13, exemplarily, the control body 1013 may be provided with a sliding portion 1015. The knob 613 may cooperate with the movable member 612 to lock or unlock the first assembly portion 61 and the sliding portion 1015, so as to implement detachable connection between the second beam 40 and the control body 1013. When the knob 613 cooperates with the movable member 612 to lock the first assembly portion 61 and the sliding portion 1015, the first assembly portion 61 and the sliding portion 1015 cannot move relative to each other, so as to ensure that the second beam 40 and the control body 1013 are connected securely. When the knob 613 cooperates with the movable member 612 to unlock the first assembly portion 61 and the sliding portion 1015, the first assembly portion 61 and the sliding portion 1015 may slide relative to each other, for example, the sliding portion 1015 may slide in the accommodation slot 614, so that the second beam 40 may be detached from the control body 1013.

Referring to FIG. 3, FIG. 4, and FIG. 8, exemplarily, the second beam 40 may be provided with a third assembly portion 41, and the third assembly portion 41 may be detachably connected to the second assembly portion 62, so as to implement detachable connection between the second beam 40 and the mounting portion 60. Exemplarily, a structure of the second assembly portion 62 may be the same or substantially the same as that of the sliding portion 1015, and a structure of the third assembly portion 41 may be the same or substantially the same as that of the first assembly portion 61.

It can be understood that the gimbal connection portion 11 may alternatively be detachably connected to the control body 1013 via another first assembly portion 61 and another sliding portion 1015. A structure of the foregoing first assembly portion 61 may be the same as or different from the structure of the first assembly portion 61 shown in FIG. 12. Similarly, a structure of the foregoing sliding portion 1015 may be the same as or different from the structure of the sliding portion 1015 shown in FIG. 13.

Certainly, in some exemplary embodiments, the second beam 40 and the control body 1013 of the gimbal 101 may alternatively be connected fixedly in a non-detachable manner, for example, the two are integrally formed. The second beam 40 and the gimbal connection portion 11 may be respectively connected to different parts of the control body 1013.

In some exemplary embodiments, the second beam 40 and the second handle 50 may cooperate to form a second combined body, and the second combined body may alternatively be replaced by the foregoing first combined body.

In some exemplary embodiments, the second handle 50 and the second beam 40 may be integrally formed or may be connected in a non-detachable manner. In some exemplary embodiments, the second handle 50 may be detachably connected to the second beam 40.

Referring to FIG. 2 to FIG. 4, in some exemplary embodiments, when the first connection member 10 and the second connection member 20 are connected in the first connection manner, the first handle 23 and the second handle 50 may be disposed symmetrically. In this way, when the first connection manner is used, the force exerted by the user on the connection assembly 102 can be more even when the user moves, thereby further ensuring that the user performs photographing stably.

Referring to FIG. 2 to FIG. 4, in some exemplary embodiments, when the first connection member 10 and the second connection member 20 are connected in the first connection manner, the first beam 21 and the second beam 40 may be arranged in a collinear manner.

Referring to FIG. 2 to FIG. 4, in some exemplary embodiments, when the first connection member 10 and the second connection member 20 are connected in the first connection manner, both the first handle 23 and the second handle 50 may be disposed on a same side of the first beam 21.

In some exemplary embodiments, when the first connection member 10 and the second connection member 20 are connected in the first connection manner, the first handle 23 and the second handle 50 may be respectively disposed on different sides of the first beam 21.

Referring to FIG. 6, in some exemplary embodiments, when the first connection member 10 and the second connection member 20 are connected in the second connection manner, the first handle 23 and the second handle 50 may be respectively disposed on different sides of the first beam 21.

Referring to FIG. 6, in some exemplary embodiments, when the first connection member 10 and the second connection member 20 are connected in the second connection manner, the first handle 23 and the second handle 50 may be respectively disposed on two opposite sides of the first beam 21.

Referring to FIG. 6, in some exemplary embodiments, when the first connection member 10 and the second connection member 20 are connected in the second connection manner, the first beam 21 may be perpendicular to the second beam 40.

In some exemplary embodiments, when the first connection member 10 and the second connection member 20 are connected in the second connection manner, the first handle 23 and the second handle 50 may alternatively be disposed on a same side of the first beam 21.

In some exemplary embodiments, the second beam 40 may alternatively be omitted, and the second handle 50 may be directly connected to the control body 1013 of the gimbal 101.

Referring to FIG. 9 to FIG. 11, in some exemplary embodiments, the locking structure 30 may include a locking member 31. The locking member 31 can pass through the first connection member 10 and the second connection member 20 to lock or release the first connection member 10 and the second connection member 20.

Exemplarily, when the gimbal 101 is used in a required operation posture, the locking member 31 may lock the first connection member 10 and the second connection member 20. When the gimbal 101 needs to switch between two operation postures, the locking member 31 may be operated, so that the locking member 31 releases the first connection member 10 and the second connection member 20. In this case, the first connection member 10 and the second connection member 20 are rotatable relative to each other.

Exemplarily, the locking member 31 may be any proper locking structure 30, for example, the locking member 31 may be a screw.

Referring to FIG. 9 to FIG. 11, in some exemplary embodiments, the locking member 31 may include an operating portion 311 and a penetrating portion 312. The penetrating portion 312 may be connected to the operating portion 311. The operating portion 311 may drive, under an external force, the penetrating portion 312 to lock or release the first connection member 10 and the second connection member 20.

When the locking structure 30 is in the locking state, the penetrating portion 312 may penetrate the second connection member 20 and be locked on the first connection member 10, thereby locking the first connection member 10 and the second connection member 20.

When the gimbal 101 needs to switch between the two operation postures, the operating portion 311 may be operated, so that the operating portion 311 drives the penetrating portion 312 to move in a release direction to release the first connection member 10 and the second connection member 20, and then the locking structure 30 becomes in the released state. When the locking structure 30 is in the released state, the first connection member 10 and the second connection member 20 may rotate relative to each other. The first connection member 10 and the second connection member 20 may rotate relative to each other until the gimbal 101 is in a target operation posture, the operating portion 311 may be operated, so that the operating portion 311 drives the penetrating portion 312 to move in a locking direction to lock the first connection member 10 and the second connection member 20, and then the locking structure 30 becomes in the locking state.

In some exemplary embodiments, the first connection member 10 and/or the second connection member 20 can rotate around the axial direction of the penetrating portion 312. In some exemplary embodiments, the first connection member 10 and/or the second connection member 20 may alternatively rotate around another real axis or imaginary axis.

Referring to FIG. 9 to FIG. 11, in some exemplary embodiments, the locking structure 30 may further include an elastic member 71. Both ends of the elastic member 71 may abut against the first connection member 10 and the second connection member 20, respectively. Specifically, both ends of the elastic member 71 may abut against the second extension arm 122 and the second rotating arm 222, respectively.

Exemplarily, when the locking structure 30 is in the locking state, a spring may be compressed, and the first connection member 10 and the second connection member 20 may be locked by the locking structure 30. When the locking structure 30 is released, the first connection member 10 and the second connection member 20 may be released under an action of the elastic member 71, that is, the elastic member 71 may push the first connection member 10 and the second connection member 20 apart.

Exemplarily, the elastic member 71 may be a spring.

Referring to FIG. 9 to FIG. 11, in some exemplary embodiments, the first connection member 10 may be provided with a limiting portion 13, and the second connection member 20 may be provided with a first matching portion 24. The limiting portion 13 may cooperate with the first matching portion 24 to limit a trajectory of relative rotation between the first connection member 10 and the second connection member 20, so that the gimbal 101 can quickly switch between different operation postures. Specifically, the second extension arm 122 may be provided with the limiting portion 13, and the second rotating arm 222 may be provided with the first matching portion 24.

In some exemplary embodiments, one of the limiting portion 13 and the first matching portion 24 may be a protruding structure, and the other of the limiting portion 13 and the first matching portion 24 may be a slot-like structure. The protruding structure can move in the slot of the slot-like structure, and the slot-like structure may limit movement of the protruding structure. Exemplarily, when the first connection member 10 and the second connection member 20 rotate relative to each other along a first direction to a first relative position, the limiting portion 13 and the first matching portion 24 may cooperate with each other to limit further movement between the first connection member 10 and the second connection member 20 along the first direction.

When the first connection member 10 and the second connection member 20 rotate relative to each other along a second direction to a second relative position, the limiting portion 13 and the first matching portion 24 may cooperate with each other to limit further movement between the first connection member 10 and the second connection member 20 along the second direction.

Exemplarily, the first relative position is shown in FIG. 7, and the second relative position is shown in FIG. 8. Exemplarily, the first relative position and the second relative position may correspond to the hand-holding attitude and the hand-carrying attitude, respectively.

Exemplarily, the second direction may be opposite to the first direction.

Exemplarily, the limiting portion 13 may be a limiting slot with a stop wall, and the first matching portion 24 may be a limiting boss. When the second extension arm 122 and the second rotating arm 222 rotate until the limiting boss is in contact with the stop wall, the stop wall can limit further rotation of the second extension arm 122 and the second rotating arm 222 toward a same direction. Exemplarily, there may be two stop walls, and the two stop walls may be respectively used to limit further movement of the limiting boss at the first relative position and the second relative position.

Referring to FIG. 9 and FIG. 10, in some exemplary embodiments, one of the first connection member 10 and the second connection member 20 may be provided with a fixing portion 14, and the other may be provided with a second matching portion 25. The fixing portion 14 can cooperate with the second matching portion 25. Exemplarily, the first connection member 10 may be provided with the fixing portion 14, and the second connection member 20 may be provided with the second matching portion 25.

In some exemplary embodiments, when the locking structure 30 is in the locking state, the fixing portion 14 may cooperate with the second matching portion 25 to prevent circumferential rotation between the first connection member 10 and the second connection member 20, and prevent rotation along an opposite direction of the stop wall, thereby further improving stability or reliability of fixation between the first connection member 10 and the second connection member 20. Exemplarily, when the locking structure 30 is in the locking state, the fixing portion 14 may cooperate with the second matching portion 25 in a snapping manner.

When the locking member 31 is released, the elastic member 71 may push the first connection member 10 and the second connection member 20 apart, so that the fixing portion 14 is disengaged from the second matching portion 25. In this case, the limiting boss and the limiting slot may slide relative to each other, and the first connection member 10 and the second connection member 20 may rotate relative to each other.

Exemplarily, the fixing portion 14 may be a fixing slot, the second matching portion 25 may be a fixing boss, and the fixing boss may cooperate with the second matching portion 25 in a snapping manner.

Referring to FIG. 11, in some exemplary embodiments, the connection assembly 102 may further include a pre-tensioning member 72. The pre-tensioning member 72 may be disposed between the first connection member 10 and the second connection member 20 for pre-tensioning the first connection member 10 and the second connection member 20 to improve hand feeling.

Exemplarily, the pre-tensioning member 72 may be a silicone ring, or the like.

The combination manner of the connection assembly 102 will be further described in detail below.

Referring to FIG. 1, the connection assembly 102 may include one handle only. The first connection member 10 and the second connection member 20 may be connected in the first connection manner. The connection assembly 102 using such connection manner may be connected to the gimbal 101 and then used in a one-hand holding mode, and the user may perform photographing by holding the first handle 23 with one hand.

Referring to FIG. 2 and FIG. 3, the connection assembly 102 may include two handles (the first handle 23 and the second handle 50). The first connection member 10 and the second connection member 20 may be connected in the first connection manner. After the connection assembly 102 is connected to the gimbal 101, a two-hand holding mode may be used. A user may hold the first handle 23 and the second handle 50 with both hands, which is helpful for the user to perform photographing at a low camera position. The user may keep the connection assembly 102 and the gimbal 101 close to the ground or directly holding it in front of the body, so as to obtain a smooth and stable image. It can be understood that when the user performs photographing at a low camera position, the connection assembly 102 and the gimbal 101 may alternatively be mounted on an aircraft. For example, the first handle 23 and the second handle 50 shown in FIG. 2 are removed and then the connection assembly 102 and the gimbal 101 may be mounted to the aircraft. In addition, the user may alternatively hold the gimbal 101 with one hand for photographing.

Referring to FIG. 4, the connection assembly 102 may include two handles (the first handle 23 and the second handle 50). The first connection member 10 and the second connection member 20 may be connected in the first connection manner. After the connection assembly 102 is mounted to the gimbal 101, a two-hand carrying mode may be used for the gimbal 101 for photographing at a high camera position. The user may hold the first handle 23 and the second handle 50 with both hands, and place the gimbal 101 on a vehicle or at another relatively high position for photographing, making a photographing angle of the photographing device 2000 higher. In this case, the user may easily turn the gimbal 101 up and down, and the camera and the eyes of the user can be kept roughly on a same horizontal line without laboriously lifting the gimbal 101. In addition, the user may alternatively carry the gimbal 101 with one hand for photographing.

Referring to FIG. 5, the connection assembly 102 may include one handle only. The first connection member 10 and the second connection member 20 may be connected in the second connection manner. The connection assembly 102 using such connection manner may be connected to the gimbal 101 and then used in a one-hand carrying mode, and a user may perform photographing by carrying the first handle 23 with one hand. This mode is applicable to a case in which the gimbal 101 follows a user for photographing, and also applicable to close-range moving photographing in a narrow space. In this case, any part of the gimbal 101 is difficult to come into contact with the body (especially the legs) of the user, so that obstruction of the gimbal 101 by the body of the user or another object caused during photographing in a narrow space may be avoided. In the one-hand carrying mode, a user may be allowed to carry the connection assembly 102 to perform close-range moving photographing in a narrow space.

Referring to FIG. 6, the connection assembly 102 may include two handles (the first handle 23 and the second handle 50). The first connection member 10 and the second connection member 20 may be connected in the second connection manner. After the connection assembly 102 is mounted to the gimbal 101, the first handle 23 and the second handle 50 may be arranged on two sides of the first beam 21, respectively. A user may carry the first handle 23 with one hand for photographing. In this mode, the center of mass of the gimbal 101 may be close to a wrist of the user, which is helpful for the user to save effort for carrying the first handle 23. In addition, the user may alternatively hold the second handle 50 with one hand for photographing.

It can be understood that, in addition to the content described above, the use mode or operation posture of the gimbal 101 may be other modes, for example, may include a mode of shoulder-carrying, airborne, vehicle-mounted, or the like. The explanation of the use mode or operation posture may not be limited by a type of a carrier for carrying the gimbal 101, a positional relationship between the gimbal 101 and the carrier for carrying the gimbal 101, an attitude of the gimbal 101 relative to the carrier for carrying the gimbal 101, or a function and a position of another accessory attached to the gimbal 101.

Referring to FIG. 3 and FIG. 4, in some exemplary embodiments, at least one of the first handle 23 and the second handle 50 may be provided with a control portion 81 for controlling the photographing device 2000. The control portion 81 may control operation of the photographing device 2000 carried on the gimbal 101 and/or control operation of the motor 1011 of the gimbal 101.

In some exemplary embodiments, the control portion 81 may include at least one of a power button configured to turn on or turn off the photographing device 2000, a shutter button configured to control the photographing device 2000 to take a picture, a recording button configured to control recording of the photographing device 2000, a trigger button configured to make the photographing device 2000 switch between operating modes, and a joystick configured to adjust a photographing angle of the photographing device 2000.

In some exemplary embodiments, the control portion 81 may further include an indicator light, configured to indicate a power level of a power supply 82 and/or indicate an operating state of the photographing device 2000, and the like. For example, the indicator light may be configured to indicate whether the photographing device 2000 is turned on, and the like.

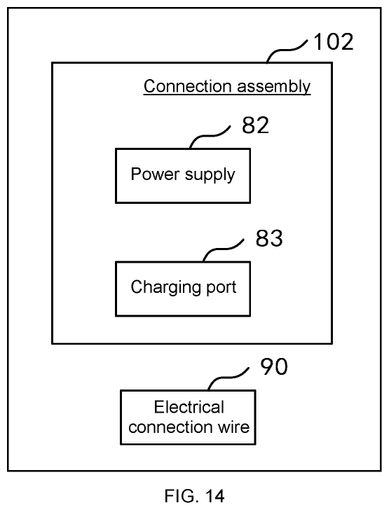

Referring to FIG. 14, in some exemplary embodiments, at least one of the first handle 23 and the second handle 50 may be provided with a power supply 82 and a charging port 83 configured to charge the photographing device 2000 or an external device. The charging port 83 may be electrically connected to the power supply 82. The power supply 82 may be configured to supply power to the photographing device 2000 and/or the motor 1011 of the gimbal 101, and the like.

Exemplarily, when the charging port 83 is electrically connected to an external charging device, the external charging device may charge the power supply 82. When the charging port 83 is electrically connected to an external electrical device, the power supply 82 may supply power to the external electrical device. It can be understood that the external charging device and the external electrical device may be a same physical entity, or may be different physical entities, which are not limited herein.

In some exemplary embodiments, the charging port 83 may be electrically connected to the photographing device 2000 by an external electrical connection wire 90 or a built-in electrical connection wire 90 disposed in the connection assembly 102, so that the first handle 23 and/or the second handle 50 are used to control the gimbal 101 and/or the photographing device 2000.

A case in which the second handle 50 is provided with the charging port 83 and the power supply 82 is used as an example for description. The first beam 21 may be provided with a wiring slot, and the electrical connection wire 90 may be electrically connected to the charging port 83 and routed from the wiring slot. In this way, the electrical connection wire 90 may be routed inside the first beam 21, so that an appearance of the connection assembly 102 is neater and more beautiful.

The foregoing descriptions are merely some exemplary embodiments of the present disclosure, but are not intended to limit the scope of protection of the present disclosure. Any equivalent modification or replacement readily figured out by a person skilled in the art within the technical scope disclosed in the present disclosure shall fall within the scope of protection of the present disclosure. Therefore, the scope of protection of the present disclosure shall be subject to the scope of protection defined by the claims.

What is claimed is:

1. A connection assembly for a gimbal, comprising:
a first connection member, being configured to connect to a gimbal;
a second connection member, being configured to connect to the first connection member; and
a locking structure having a locking state and a released state, wherein
in the locking state, the locking structure is capable of locking the first connection member and the second connection member, and
in the released state, the locking structure allows the first connection member and the second connection member to rotate relative to each other so as to allow the gimbal to switch between at least two operation postures.

2. The connection assembly according to claim 1, wherein the first connection member includes:
a gimbal connection portion, connected to the gimbal; and
an extension portion, connected to the gimbal connection portion, wherein
the extension portion is connectable to the second connection member or rotatable relative to the second connection member.

3. The connection assembly according to claim 2, wherein the gimbal connection portion is detachably connected to the gimbal.

4. The connection assembly according to claim 3, wherein the extension portion includes:
a first extension arm, a first end of the first extension arm being connectable to the gimbal connection portion; and
a second extension arm, bending and extending from a second end of the first extension arm, and connectable to the second connection member or rotatable relative to the second connection member.

5. The connection assembly according to claim 4, wherein the first extension arm is perpendicular to the gimbal connection portion.

6. The connection assembly according to claim 4, wherein an angle between the first extension arm and the second extension arm ranges from 100° to 170°.

7. The connection assembly according to claim 4, wherein the second extension arm bends and extends from the second end of the first extension arm toward a side away from the second connection member.

8. The connection assembly according to claim 4, wherein the second connection member includes:
a first beam; and
a rotating portion, connected to the first beam and the extension portion, wherein the rotating portion is connectable to the second extension arm or rotatable relative to the second extension arm.

9. The connection assembly according to claim 8, wherein a shape of the rotating portion is matched with a shape of the extension portion.

10. The connection assembly according to claim 8, wherein the rotating portion includes:
a first rotating arm, a first end of the first rotating arm being connected to the first beam; and
a second rotating arm, bending and extending from a second end of the first rotating arm, wherein the second rotating arm is connectable to the second extension arm or rotatable relative to the second extension arm.

11. The connection assembly according to claim 10, wherein an angle between the first rotating arm and the second rotating arm ranges from 100° to 170°.

12. The connection assembly according to claim 10, wherein the second rotating arm bends and extends from the second end of the first rotating arm toward a side away from the first beam.

13. The connection assembly according to claim 10, wherein the first connection member and the second connection member are rotatable relative to each other to switch between a first connection manner and a second connection manner, so as to allow the gimbal to switch between a hand-holding attitude and a hand-carrying attitude.

14. The connection assembly according to claim 13, wherein when the first connection member and the second connection member are connected in the first connection manner, at least one of the following occurs:
the first rotating arm being parallel to the first extension arm, or the second rotating arm being parallel to the second extension arm.

15. The connection assembly according to claim 14, wherein when the first connection member and the second connection member are connected in the first connection manner, at least one of the following occurs:
the first rotating arm being attached to the first extension arm, or
the second rotating arm being attached to the second extension arm.

16. The connection assembly according to claim 13, wherein when the first connection member and the second connection member are connected in the first connection manner, the first rotating arm is perpendicular to the gimbal connection portion.

17. The connection assembly according to claim 13, wherein when the first connection member and the second connection member are connected in the first connection manner, the gimbal connection portion and the first beam are arranged in a collinear manner.

18. The connection assembly according to claim 13, wherein when the first connection member and the second connection member are connected in the second connection manner, an angle between the first rotating arm and the first extension arm is an acute angle, and the second rotating arm is parallel to the second extension arm.

19. The connection assembly according to claim 13, wherein when the first connection member and the second connection member are connected in the second connection manner, both the second extension arm and the second rotating arm are located between the first extension arm and the first rotating arm.

20. The connection assembly according to claim 13, wherein when the first connection member and the second connection member are connected in the second connection manner, the first rotating arm and the gimbal connection portion are disposed in parallel at an interval.
